(19) United States
(12) Patent Application Publication
(10) Pub. No.: US 2014/0209280 A1
(43) Pub. Date: Jul. 31, 2014

(54) THERMAL-STORAGE EVAPORATOR WITH INTEGRATED COOLANT TANK

(71) Applicant: VISTEON GLOBAL TECHNOLOGIES, INC., Van Buren Twp., MI (US)

(72) Inventor: Lakhi Nandlal Goenka, Ann Arbor, MI (US)

(73) Assignee: VISTEON GLOBAL TECHNOLOGIES, INC., Van Buren Twp., MI (US)

(21) Appl. No.: 13/753,587

(22) Filed: Jan. 30, 2013

(51) Int. Cl. H01M 10/66; F28D 15/02

(52) U.S. Cl. CPC H01M 10/5093; F28D 15/02
USPC 165/104.14

(57) ABSTRACT

An integrated thermal transfer system is provided for transferring heat between a coolant and a refrigerant in an HVAC system to change a temperature of the coolant. Heat is then transferred between the coolant having a changed temperature and a device in need of thermal control, such as a battery. The system includes an evaporator having a refrigerant tank, where the refrigerant tank contains the refrigerant. A coolant tank is disposed adjacent and in thermal communication with the refrigerant tank, the coolant tank including an inlet and an outlet, where the coolant tank contains the coolant. The device is fluidly coupled to the inlet and the outlet of the coolant tank.

### FIELD OF THE INVENTION

The present technology relates to a coolant tank integrated with an evaporator, particularly in systems where a coolant is used to modify the temperature of a battery.

### INTRODUCTION OF THE INVENTION

This section provides background information related to the present disclosure which is not necessarily prior art.

Various devices within a vehicle may require various degrees of temperature regulation in order to operate at or near optimal conditions. One such device includes a battery. For example, one or more batteries are used in electric vehicles or hybrid vehicles to provide a voltage to operate drivetrains and other electrical systems. In some cases, a plurality of battery cells is employed that uses electrochemical principles of oxidation with an electrolyte, thereby producing heat. During operation, the battery cells of the battery as well as other components of the vehicle's electrical drivetrain, such as the electric motor and the power electronics, can accordingly change temperature and can heat up. It is often desirable to operate the battery at a particular temperature or within a particular temperature range, especially during discharging and charging, in order to maximize the efficiency and lifespan of the battery. Any heat generated and liberated in such processes should be dissipated, as an elevated operating temperature can result in thermal loading on the battery.

Many battery types have limited temperature resistance and it is desirable to actively control the temperature of the battery so that the temperature of the battery varies only within a limited range. As such, battery management can often include dissipating any generated heat. Conversely, heat can be supplied to a cold battery if the ambient temperature is too low, for example, when starting the vehicle. Media for cooling the temperature of the battery and other electronic components of the drivetrain can include air sources, such as ambient air and air routed from the vehicle interior, and through the use of refrigerants or coolants. Water and/or glycol, for example, can be used as a coolant. Controlling the temperature of the battery in this manner can increase its efficiency and lifespan.

Temperature control and battery management can be achieved by using a heat exchanger, also known as battery cooler or chiller. In hybrid vehicles, the chiller can be connected to a coolant circuit of an engine, and in electric vehicles, the chiller can be connected to a refrigerant circuit of a heating, ventilation, and air conditioning (HVAC) system. The chiller can operate as an evaporator with respect to the refrigerant. The refrigerant, which can be in two-phases upon entering the evaporator, is evaporated and superheated, if necessary. A thermostatic expansion valve can be connected upstream of the chiller to control constant superheating at the outlet of the chiller. A shut-off function can be integrated in the thermostatic expansion valve for the operating state in which no refrigerating capacity is required at the chiller. The shut-off function can be implemented using a solenoid valve or a stepping motor valve.

When the temperature of the battery exceeds an upper switching limit, the battery can be cooled. The solenoid valve is opened and the refrigerating capacity adjusts “automatically” via the thermostatic expansion valve, cooling the battery. When dropping below a lower switching limit, the solenoid valve can close and the temperature of the battery can slowly rise. Since control of the thermostatic expansion valve may be mechanical, the appropriate refrigerating capacity for cooling the battery may not be provided, which reduces the efficiency of the battery cooling process. The battery may therefore be cooled more than necessary and as a result may be operated less efficiently. As the required cooling capacity increases, the electrical power generated for operating the battery cooling increases as well.

Chillers can be operated in parallel with an evaporator when conditioning the air of the vehicle interior. Since the refrigerant lines are connected to each other downstream of the respective evaporator and chiller, the refrigerant has the same pressure, and therefore, the same evaporation temperature level, in both components, The pressure and temperature level in the chiller cannot be controlled independent of the evaporator of the vehicle air-conditioning system. An example of a system that uses a chiller for battery cooling is described in U.S. Pub. No. 2011/0174000 to Richter et al., the entire disclosure of which is incorporated herein by reference.

Using a chiller in parallel with an evaporator can make it difficult to provide independent temperature regulation of the evaporator and HVAC system in view of thermally controlling various devices, such as the battery. Problems further arise when using a chiller to control the temperature of a battery due to the increased cost and complexity of the system. It is desirable to provide improved thermal transfer systems, including systems that provide more control and temperature regulation options and systems that reduce manufacturing and operational complexity.

### SUMMARY OF THE INVENTION

The present technology includes systems, processes, articles of manufacture, and compositions that relate to integrated thermal transfer systems and methods of using such systems.

An integrated thermal transfer system according to the present technology includes an evaporator having a refrigerant tank. A coolant tank is adjacent and in thermal contact with the refrigerant tank, where the coolant tank includes an inlet and an outlet. A device in need of thermal control is fluidly coupled to the inlet and the outlet of the coolant tank. In some embodiments, the device in need of thermal control is a battery.

A method of using the integrated thermal transfer system includes transferring heat between a coolant in the coolant tank and a refrigerant in the refrigerant tank to change the temperature of the coolant. Heat is further transferred between the coolant having a changed temperature and the device in need of thermal control.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic of an integrated thermal transfer system according to one embodiment of the present technology.

FIG. 2 is a schematic of an integrated thermal transfer system according to another embodiment of the present technology.

FIG. 3 is a schematic of an integrated thermal transfer system according to another embodiment of the present technology.

### DETAILED DESCRIPTION OF THE INVENTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding the methods disclosed, the order of the steps presented is exemplary in nature, and thus, the order of the steps can be different in various embodiments. Except in the examples, or where otherwise expressly indicated, all numerical quantities in this description are to be understood as modified by the word “about” in describing the broadest scope of the technology.

The present technology includes integrated thermal transfer systems and methods of using such systems to exchange heat between a refrigerant and a coolant, where the coolant can be used to thermally control one or more devices. For example, an HVAC system can use a refrigerant with an evaporator for modifying the temperature of an air flow. A portion of the refrigerant can be contained in one or more tanks such as a refrigerant inlet tank and/or a refrigerant outlet tank. A coolant tank can be disposed adjacent the refrigerant tank so that the coolant tank is in thermal contact with the refrigerant tank. In this way, thermal energy can be transferred between the refrigerant tank and the coolant tank. The coolant can then be used to modify the temperature of one or more devices in need of thermal control, such as a battery.

With reference to the Figures, an integrated thermal transfer system is shown at 100. The system 100 includes an evaporator 105, a coolant tank 110, and a device 115 in need of thermal control. The evaporator 105 includes a refrigerant tank 120. The coolant tank 110 is adjacent and in thermal contact with the refrigerant tank 120 and has an inlet 125 and an outlet 130. The device 115 in need of thermal control is fluidly coupled to the inlet 125 and the outlet 130 of the coolant tank 110. For example, the device 115 can be coupled to the inlet 125 and the outlet 130 via conduits 135.

The evaporator 105 operates to cause a phase change in a refrigerant contained therein or moving therethrough, where the transition from the liquid phase of the refrigerant to the gas phase of the refrigerant absorbs heat in the process. Configuration of the evaporator 105 can include one or more evaporator tubes (not shown) where evaporation or vaporization of the refrigerant occurs. Another fluid stream such as a flow of air depicted by the block arrows in the Figures can be in thermal contact with the evaporator tubes in order to transfer heat between the fluid stream and the evaporator tubes containing the refrigerant. In this way, liquid refrigerant is vaporized within the evaporator tubes and absorbs heat from the fluid stream. Where the fluid stream is air, for example, the resulting cooled air can be provided to the interior of a vehicle as part of an HVAC system. For example, the evaporator 105 can have an evaporator tube positioned within an airflow conduit, where the evaporator tube is fluidly coupled to the refrigerant tank 120.

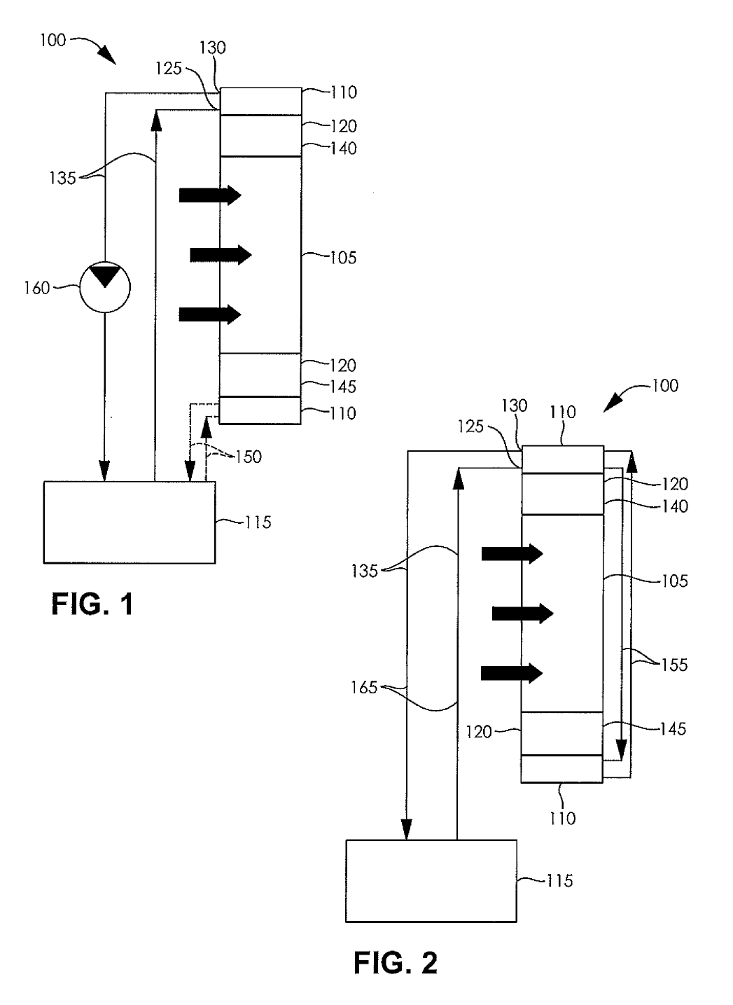

The refrigerant tank 120 can be one of a refrigerant inlet tank 140 and a refrigerant outlet tank 145. For example, as shown in FIG. 1, the refrigerant tank 120 can be the refrigerant inlet tank 140, where the coolant tank 110 is adjacent and in thermal communication with the refrigerant inlet tank 140. In this case, the coolant tank 110 is coupled to the device 115 via conduits 135. Alternatively, the refrigerant tank 120 can be the refrigerant outlet tank 145. Here, the coolant tank 110 is adjacent and in thermal communication with the refrigerant outlet tank 145 and the coolant tank 110 is coupled to the device 115 via conduits 150 shown in stippled lines. The refrigerant tank 120 can also include both a refrigerant inlet tank 140 and a refrigerant outlet tank 145. An example is shown in FIG. 2, where coolant tanks 110 are adjacent and in thermal communication with the refrigerant inlet tank 140 and the refrigerant outlet tank 145 and the coolant tanks 110 are coupled via conduits 155. The coolant tanks 110 are also coupled to the device 115 via conduits 135. In certain embodiments, the refrigerant tank 120, including the refrigerant inlet tank 140 and/or refrigerant outlet tank 145, can be positioned adjacent an airflow conduit of the evaporator 105, where the airflow is depicted as block arrows in the Figures.

In some embodiments, the coolant tank 110 is in thermal communication with the refrigerant inlet tank 140 and in other embodiments the coolant tank 110 is in thermal communication with the refrigerant outlet tank 145. Still further embodiments include where the coolant tank 110 is in thermal communication with the refrigerant inlet tank 140 and the refrigerant outlet tank 145. By thermal communication, it is meant that the coolant tank 110 and the refrigerant tank 120 are configured to exchange thermal energy (i.e., heat) therebetween. For example, the coolant tank 110 and the refrigerant tank 120 can be in thermal communication where each is fabricated using a thermally conductive material and the coolant tank 110 and the refrigerant tank 120 are in direct contact with each other.

As described, the coolant tank 110 includes the inlet 125 and the outlet 130 that are fluidly coupled to the device 115 in need of thermal control. The coolant tank 110 is positioned adjacent the refrigerant tank 120 and is in thermal communication with the refrigerant tank 120. In some embodiments, the coolant tank 110 can be a reservoir for containing a volume of coolant. The inlet 125 and the outlet 130 of the coolant tank 110 can be fluidly coupled to the device 115 using various types of fluid couplings, such as the conduit 135, where the coolant can pass into the coolant tank 110 through the inlet 125 and pass out of the coolant tank 110 through the outlet 130. Coolant can travel through the conduit 135 to the device 115 via the outlet 130 to exchange heat and thermally control the device 115. Coolant can return from the device 115 to the inlet 125 and into the coolant tank 110, making a complete cycle.

When the coolant is at the device 115 in need of thermal control, the conduit 135 containing the coolant can be coupled to a heat exchanger or flow field (not shown) configured to transfer heat between the coolant and the device 115. In some cases, the conduit 135 may be coupled to one or more flow channels within the device to pass the coolant therethrough and return the coolant via the conduit 135 to the coolant tank 110. In certain embodiments, the conduit 135 containing the coolant is simply placed in thermal communication with the device 115, where the conduit 135 can wrap around or wind in a serpentine pattern along the device 115 to increase a contact area between the conduit 135 and the device 115 and hence, increase thermal transfer with the device 115.

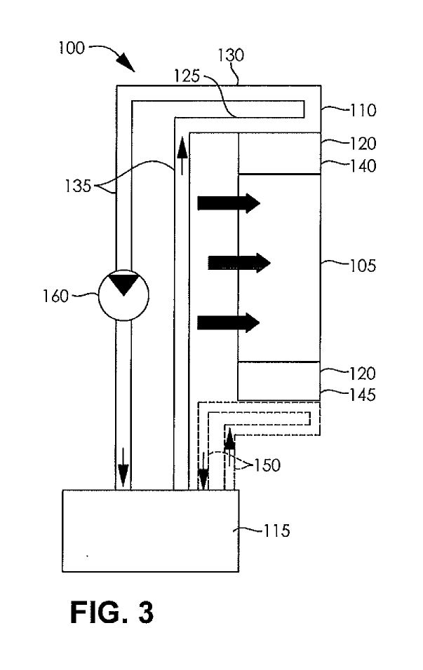

In other embodiments, the coolant tank 110 can be a portion of the conduit 135 that is adjacent and in thermal communication with the refrigerant tank 120 as shown in FIG. 3. In this way, there is no defined reservoir holding a volume of coolant, but instead a length of the conduit 135 operates as the coolant tank 110 and provides heat transfer with the refrigerant tank 120. As shown in FIG. 3, the length of conduit 135 that is operating as the coolant tank 110 can be configured as a hairpin with one side adjacent and in thermal communication with the refrigerant tank 120. However, in various embodiments the conduit 135 portion configured as the coolant tank 110 can wrap around or wind in a serpentine pattern along the refrigerant tank 120 to increase a contact area between the conduit 135 portion and the refrigerant tank 120 and hence increase thermal transfer with the refrigerant tank 120. The coolant tank 110 portion of the conduit 135 can further be in the form of a flow field where the inlet 125 is branched into a plurality of channels in contact with the refrigerant tank that subsequently coalesce back into a single outlet 130 for the coolant tank 110.

The conduit 135 used to fluidly couple the inlet 125 and the outlet 130 of the coolant tank 110 to the device 115 in need of thermal control can take various forms. Various cross-sectional shapes can be employed, for example, where the conduit 135 has a generally circular cross-section in coupling the coolant tank 110 and the device 115 in need of thermal control. The cross-section of the conduit 135 can also deviate from circular where the conduit is flattened against the refrigerant tank 120 and/or the device 115 in need of thermal control. In this fashion, a surface area between the conduit 135 and the refrigerant tank 120 and/or the device 115 can be increased to more effectively transfer thermal energy. The conduit 135 can also have a D-shaped cross-section, where the flat edge of the D-shape is adjacent and in thermal communication with the refrigerant tank 120 and/or the device 115. The conduit 135 can be soldered or brazed to the refrigerant tank 120 and/or the device 115.

With reference to FIG. 1, a pump 160 can be used to facilitate flow of coolant between the coolant tank 110 and the device 115 in need of thermal control. In particular, the pump 160 can be operable to control the flow of the coolant between the device 115 in need of thermal control and the coolant tank 110. Flow control can be used to control the thermal transfer rate between the coolant tank 110 and the device 115 in need of thermal control. Where the pump 160 is an electrical coolant pump, the flow of coolant can be controlled in response to one or more temperature sensors positioned throughout the system (not shown). For example, the pump 160 can be coupled to the conduit 135 between the device 115 and the inlet 125 of the coolant tank, or the pump can be coupled to the conduit 135 between the outlet 130 of the coolant tank and the device 115, as shown in FIG. 1.

In some embodiments, the coolant tank 110 and the device 115 in need of thermal control are fluidly coupled using a heat pipe 165. At the higher thermal energy side of the heat pipe 165, typically at a lower pressure, the coolant in liquid form is in contact with a thermally conductive solid surface, turning the liquid coolant into vapor by absorbing heat from that surface. For example, the heat pipe 165 can absorb heat from the device 115 in need of thermal control. The vapor then travels along the heat pipe 165 to the lower thermal energy side, condenses back into a liquid, releasing the latent heat. For example, the latent heat can be released at the coolant tank 110. The liquid then returns to the high thermal energy side through either capillary action or gravity action where it evaporates once more and repeats the cycle. In addition, the internal pressure of the heat pipe 165 can be set or adjusted to facilitate the phase change depending on the demands of the working conditions of the integrated thermal transfer system 110. In certain embodiments, the heat pipe 165 can be a loop heat pipe. The loop heat pipe can operate using capillary action to remove heat from the device in need of thermal control, for example, and passively move the heat to the coolant tank 110 that is in thermal communication with the refrigerant tank 120.

Various devices 115 in need of thermal control can be included in the present system 100. As already described, the device 115 in need of thermal control can include a battery. Other devices 115 in need of thermal control include one or more heat exchangers and phase change materials. For example, thermal control of a heat exchanger can be used to regulate the temperature of other systems or components in a vehicle. Thermal control of a phase change material can be used to maintain one phase of the phase change material or transfer heat with the phase change material. For example, the phase change material can serve as a store of latent heat that can be transferred to the coolant tank 110 and subsequently the refrigerant tank 120. Alternatively, heat from the refrigerant tank 120 can be transferred to the coolant tank 110 and subsequently to the phase change material where it is stored.

The integrated thermal transfer systems 100 described herein can be used and operated in various ways. In one method, the integrated thermal transfer system 100 is provided where the system comprises the evaporator 105, the coolant tank 110, and the device 115 in need of thermal control. The evaporator 105 includes the refrigerant tank 120 that contains the refrigerant. The coolant tank 110 is disposed adjacent and in thermal communication with the refrigerant tank 120 and includes the inlet 125 and the outlet 130. The coolant is contained within the coolant tank 110. The device 115 in need of thermal control is fluidly coupled to the inlet 125 and the outlet 130 of the coolant tank 110. Heat is transferred between the coolant and the refrigerant to change the temperature of the coolant. Heat is further transferred between the coolant having a changed temperature and the device 115 in need of thermal control. The integrated thermal transfer system 100 can be configured in various ways, as already described herein. For example, the refrigerant tank 120 can include at least one of the refrigerant inlet tank 140 and the refrigerant outlet tank 145.

Further operating methods include where the step of transferring heat between the coolant and the refrigerant to change the temperature of the coolant comprises transferring heat from the coolant to the refrigerant. In certain methods, transferring heat between the coolant having a changed temperature and the device 115 in need of thermal control comprises transferring heat from the device 115 in need of thermal control to the coolant. Transferring heat between the coolant having a changed temperature and the device 115 in need of thermal control can also include pumping the coolant between the coolant tank 110 and the device 115 in need of thermal control. And, in some embodiments, the device 115 in need of thermal control is fluidly coupled to the coolant tank 110 via the heat pipe 165.

The present technology provides several benefits and advantages. These include the fact that cooling of the device 115 in need of thermal control does not require an added airside or refrigerant pressure drop in the evaporator 105 of the system 100. The integrated thermal transfer system 100 can also provide a minimal increase in packaging space required by the evaporator 105 and the overall refrigerant system, where the additional space necessary for the integrated coolant tank can be positioned exterior to the airflow within the evaporator 105 and the HVAC unit as a whole. Use of the pump 160 can also have a minimal effect on pulldown cooling. The integrated thermal transfer system 100 can also be fabricated as a unit to reduce complexity and minimize manufacturing costs. It is further possible to use the system 100 to independently regulate the temperature of the device 115 in need of thermal control.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. An integrated thermal transfer system comprising:
an evaporator including a refrigerant tank;
a coolant tank in thermal communication with the refrigerant tank, the coolant tank including an inlet and an outlet; and
a device in need of thermal control fluidly coupled to the inlet and the outlet of the coolant tank.

2. The system of claim 1, wherein the refrigerant tank comprises one of a refrigerant inlet tank and a refrigerant outlet tank.

3. The system of claim 2, wherein the refrigerant tank comprises the refrigerant inlet tank and the coolant tank is in thermal communication with the refrigerant inlet tank.

4. The system of claim 2, wherein the refrigerant tank comprises the refrigerant outlet tank and the coolant tank is in thermal communication with the refrigerant outlet tank.

5. The system of claim 1, wherein the refrigerant tank comprises a refrigerant inlet tank and a refrigerant outlet tank and the coolant tank is in thermal communication with one of the refrigerant inlet tank and the refrigerant outlet tank.

6. The system of claim 5, wherein the coolant tank is in thermal contact with the refrigerant inlet tank and the refrigerant outlet tank.

7. The system of claim 1, wherein the evaporator comprises an airflow conduit including an evaporator tube, the evaporator tube fluidly coupled to the refrigerant tank.

8. The system of claim 7, wherein the refrigerant tank is adjacent the airflow conduit.

9. The system of claim 1, further comprising a pump controlling the flow of a fluid between the device in need of thermal control and the coolant tank.

10. The system of claim 9, wherein the pump is an electrical coolant pump.

11. The system of claim 1, wherein the device in need of thermal control is fluidly coupled to the coolant tank with a heat pipe.

12. The system of claim 1, wherein the device in need of thermal control comprises a battery.

13. The system of claim 1, wherein the device in need of thermal control comprises one of a heat exchanger and a phase change material.

14. The system of claim 1, wherein the coolant tank comprises a conduit in thermal communication with the refrigerant tank.

15. A method of using an integrated thermal transfer system comprising:
providing an integrated thermal transfer system comprising:
an evaporator including a refrigerant tank, wherein the refrigerant tank contains a refrigerant;
a coolant tank in thermal communication with the refrigerant tank, the coolant tank including an inlet and an outlet, wherein the coolant tank contains a coolant; and
a device in need of thermal control fluidly coupled to the inlet and the outlet of the coolant tank;
transferring heat between the coolant and the refrigerant to change a temperature of the coolant; and
transferring heat between the coolant having a changed temperature and the device in need of thermal control.

16. The method of claim 15, wherein the refrigerant tank comprises one of a refrigerant inlet tank and a refrigerant outlet tank.

17. The method of claim 15, wherein transferring heat between the coolant and the refrigerant to change the temperature of the coolant comprises transferring heat from the coolant to the refrigerant.

18. The method of claim 15, wherein transferring heat between the coolant having the changed temperature and the device in need of thermal control comprises transferring heat from the device in need of thermal control to the coolant.

19. The method of claim 15, wherein transferring heat between the coolant having the changed temperature and the device in need of thermal control comprises pumping the coolant between the coolant tank and the and the device in need of thermal control.

20. The method of claim 15, wherein the device in need of thermal control is fluidly coupled to the coolant tank via a heat pipe.
